(19) United States
(12) Patent Application Publication
(10) Pub. No.: US 2009/0226805 A1
(43) Pub. Date: Sep. 10, 2009

(54) Battery

(76) Inventors: Robert Yoppolo, New Milford, CT (US); Alexander B. Shelekhin, Ridgefield, CT (US); David L. Anglin, Brookfield, CT (US)

Correspondence Address: FISH & RICHARDSON P.C., P.O. BOX 1022, MINNEAPOLIS, MN, 55440-1022, US

(21) Appl. No.: 12/044,347

(22) Filed: Mar. 7, 2008

(51) Int. Cl. H01M 2/02

(52) U.S. Cl. 429/163

(57) ABSTRACT

AAA battery has a cathode having a height of at least 44.6 mm and/or an interior surface area of at least 1240 mm². AAAA battery has a cathode having a height of at least 39.0 mm and/or an interior surface area of at least 795 mm².

### TECHNICAL FIELD

This invention relates to batteries.

### BACKGROUND

Batteries are commonly used as electrical energy sources. A battery contains a negative electrode, typically called the anode, and a positive electrode, typically called the cathode. The anode contains an active material that can be oxidized. The cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

AA and AAA batteries have standard sizes under International Electrotechnical Commission (IEC) standards. AAA battery can have a maximum length of 50.5 mm with a minimum distance from the pip end to the negative contact of 49.2 mm and a diameter ranging from 13.5 mm to 14.5 mm, and a AAA battery can have a maximum length of 44.5 mm with a minimum distance from the pip end to the negative contact of 43.3 mm and a diameter ranging from 9.5 mm to 10.5 mm.

### SUMMARY

The invention generally relates to AA and AAA batteries including a housing and an anode and a cathode within the housing. The cathode has a height and/or interior surface area that provides a battery with good overall performance.

In one aspect, the invention features a AA battery in which the interior surface of the cathode adjacent to the anode has a surface area of at least 1240 mm².

In another aspect, the invention features a AAA battery which the interior surface of the cathode adjacent to the anode has a surface area of at least 795 mm².

In another aspect, the invention features a AA battery in which the cathode has a height of at least 44.6 mm.

In another aspect, the invention features a AAA battery in which the cathode has a height of at least 39.0 mm.

Embodiments of the above batteries may include one or more of the following features. The cathode can have a porosity of at least 26%. The anode can include zinc and the cathode can include electrolytically synthesized manganese dioxide. The cathode can be cylindrical. The battery can include one of the seals disclosed subsequently.

Embodiments of the AA battery may include any one or more of the following features. The surface area of the interior surface can be at least 1250 mm², at least 1278 mm², or between 1250 mm and 1310 mm². The cathode can have a height of at least 45.5 mm, at least 45.8 mm, or between 44.6 mm and 46.8 mm.

Embodiments of the AAA battery may include any one or more of the following features. The surface area of the interior surface can be at least 800 mm² or between 800 mm² and 833 mm². The cathode can have a height of at least 39.1 mm, at least 39.3 mm 39.5 mm, or between 39.1 mm and 40.5 mm.

The batteries may be primary or secondary batteries. Primary electrochemical cells are meant to be discharged, e.g., to exhaustion, only once, and then discarded. Primary cells are not intended to be recharged. Primary cells are described, for example, in David Linden, Handbook of Batteries (McGraw-Hill, 2d ed. 1995). Secondary electrochemical cells can be recharged for many times, e.g., more than fifty times, more than a hundred times, or more. Secondary cells are described, e.g., in Falk & Salkind, “Alkaline Storage Batteries”, John Wiley & Sons, Inc. 1969; U.S. Pat. No. 345,124; and French Patent No. 164,681.

The invention also features making the batteries by inserting an anode, a cathode, a separator, and an electrolyte into a housing, and then sealing the housing.

The invention also features using the batteries.

The determination of the surface area of the interior surface of the cathode is described in the detailed description.

“Cylindrical”, as used herein, means shaped like a tube. For example, the housing of AA and AAA batteries are cylindrical.

The battery can have an increased service life when a cathode with an increased cathode column height is included. The battery discharge efficiency can be enhanced with added surface area of the anode and cathode interfacial area as the cathode height increases.

All publications, patent applications, patents, and other references mentioned herein are incorporated by reference herein in their entirety.

Other features and advantages of the invention will be apparent from the following detailed description, and from the claims.

### DESCRIPTION OF DRAWINGS

FIG. 1 is a schematic diagram of a battery.

FIG. 2 is a schematic diagram of a cylindrical cathode.

FIG. 3 is schematic diagram of another battery.

Like reference symbols in the various drawings indicate like elements.

### DETAILED DESCRIPTION

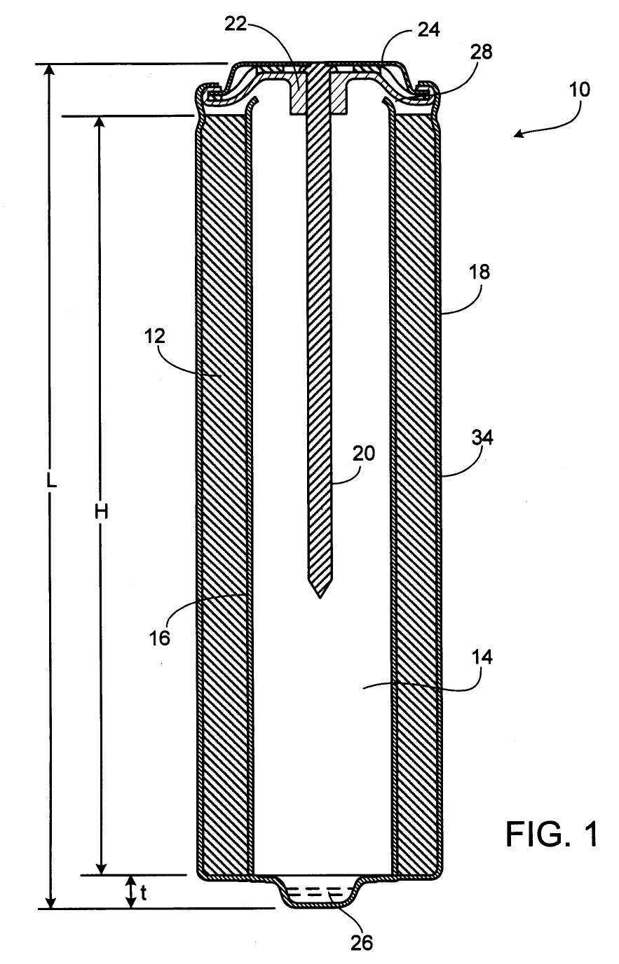

Referring to FIG. 1, battery 10 includes a cathode 12 containing a cathode material 13, an anode 14, a separator 16 and a cylindrical housing 18. Battery 10 also includes current collector 20, seal 22, and a negative metal end cap 24, which serves as the negative terminal for the battery. A positive pip 26, which serves the positive terminal of the battery, is at the opposite end of the battery from the negative terminal. An electrolytic solution is dispersed throughout battery 10. Battery 10 can be, for example, a AA or AAA battery.

Seal 22 includes a downwardly extending wall 28 and is a part of an end cap seal assembly. Detailed description of such an end cap seal assembly is provided in U.S. patent application Ser. No. 11/590,561, filed on Oct. 31, 2006.

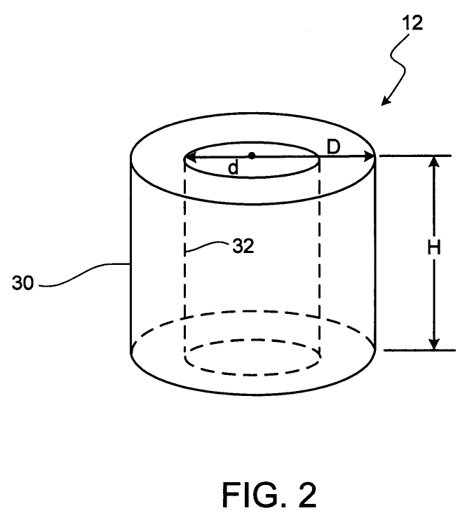

Referring to FIG. 2, cylindrical cathode 12 has a height H, an inner diameter d, and an outer diameter D. Cathode 12 includes an exterior surface 30 in contact with housing 18 and an interior surface 32 adjacent to anode 14.

Referring back to FIG. 1, battery 10 has a total length L and pip 26 has a height t. Battery 10 can be a AA battery having a total length L of about 50.5 mm and a pip height t of at least 1.0 mm, e.g., at least 1.1 mm or at least 1.2 mm or at least 1.3 mm. In a AA battery, cathode 12 has a height H of at least, e.g., 44.6 mm, 44.7 mm, 44.8 mm, 44.9 mm, 45.0 mm, 45.1 mm, 45.2 mm, 45.3 mm, 45.5 mm, 45.6 mm, or 45.8 mm and/or up to, e.g., 46.8 mm, 46.7 mm, 46.6 mm, 46.5 mm, 46.4 mm, 46.3 mm, 46.2 m, 46.1 mm, or 46.0 mm.

Battery 10 can also be a AAA battery having a total length L of about 44.5 mm and a pip height t of at least 0.8 mm, e.g., at least 0.9 mm or at least 1.0 mm. In a AAA battery, cathode 12 has a height H of at least, e.g., 39.0 mm, 39.1 mm, 39.3 mm, 39.5 mm, or 39.6 mm and/or up to, e.g., 40.5 mm, 40.3 mm, 40.1 mm, 40.0 mm, or 39.8 mm.

The cathode height H in battery 10 allows a flexible design and processing of battery 10. For example, the total volume of cathode 12 is increased and a greater amount of cathode material can be loaded into battery 10. Thus a higher discharge capacity and a longer battery duration can be provided. The cathode height can also allow the inner diameter d and the surface area of interior surface 32 of cathode 12 to be increased without reducing the total volume of cathode 12. The surface area of interior surface 32, as defined herein, equals the cathode height H multiplied by the circumference of a circle having inner diameter d in FIG. 2. The cathode height also can enable a higher porosity of cathode 12. The porosity of a cathode as defined herein, equals the difference between the total volume of a cathode and the volume of solid chemicals in the cathode divided by the total volume of the cathode.

When battery 10 is a AA battery, the surface area of interior surface 32 can be at least, e.g., 1240 mm², 1250 mm², 1253 mm², 1260 mm², 1270 mm², 1278 mm², or 1280 mm² and/or up to, e.g., 1260 mm², 1270 mm², 1278 mm², 1280 mm², 1290 mm², 1300 mm², 1306 mm², 1310 mm² or 1320 mm².

When battery 10 is a AAA battery, the surface area of interior surface 32 can be at least, e.g., 790 mm², 795 mm², 800 mm², 805 mm², or 810 mm² and/or up to, e.g., 838 mm², 833 mm², 830 mm², 825 mm², or 820 mm².

The large surface area of interior surface 32 provides a large interfacial area between cathode 12 and anode 14 and can increase discharge efficiency.

Cathode 12 can have a high porosity. For example, for both AA and AAA batteries, the porosity of cathode 12 is at least, e.g., 25.5%, 26%, 26.5%, or 27% and/or can be up to, e.g., 29%, 28.5%, or 28%. The high porosity of cathode 12 can enhance discharge efficiency of battery 10 by ionic diffusion rate. The porosity of cathode 12 is measured after insertion or formation of the cathode material in battery 10 and prior to filling anode 14 and electrolyte in battery 10.

The high porosity of cathode 12 can also improve the battery duration. The high porosity of cathode 12 can minimize expansion and/or distortion of battery 10 during its processing and discharge. The pores in cathode 12 provides space for expansion of the components within battery 10 without substantially distorting housing 18. A thin housing wall 34, for example, having a thickness of about 0.15 mm to about 0.20 mm, can be used. The internal volume of battery 10 is therefore increased and more active ingredient can be housed in.

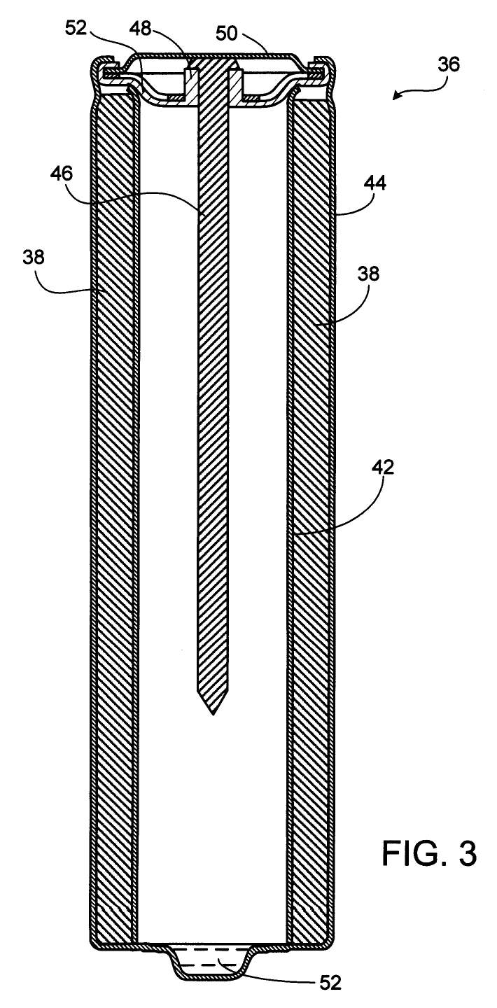

The overall performance of a battery, such as duration, discharge capacity, or discharge efficiency, can be affected by the multiple elements, such as the height, interior surface area, and porosity of cathode 12, the thickness of housing wall, the amount of active ingredients housed in a specific type of battery, and the distortion of housing 18 discussed above. These elements are dependent from each other and a larger cathode height provides room for optimization of the other elements and therefore facilitates achieving a better performance of the battery. The interplay of these elements in optimizing the battery performance is further shown in the examples. Referring now to FIG. 3, battery 36 includes a cathode 38, an anode 40, a separator 42 and a cylindrical housing 44. Battery 36 also includes current collector 46, seal 48, and a negative metal end cap 50, which serves as the negative terminal for the battery. A positive pip 52, which serves the positive terminal of the battery, is at the opposite end of the battery from the negative terminal. An electrolytic solution is dispersed throughout battery 36. Battery 36 can also be, for example, a AA or AAA, battery.

Seal 48 includes a upwardly extending wall 52 and is a part of an end cap seal assembly. Detailed description of such end cap seal assembly is provided in U.S. patent application Ser. No. 11/650,405, filed on Jan. 5, 2007.

Cathode 38 has the same cylindrical shape as cathode 12, which is shown in FIG. 2 in detail. The cathode height, interior surface area, and porosity of cathode 38 are within the same range as those of cathode 12.

Cathodes 12 and 38 include one or more cathode active materials. They may also include carbon particles, a binder, and other additives.

Examples of cathode active material include manganese dioxide, nickel oxyhydroxide, iron disulfide, silver oxide, and copper oxide. Generally the cathode may include, for example, between 80 wt % and 90 wt %, and preferably between 86 wt % and 88 wt %, of cathode active material.

Manganese dioxide can be in any of the conventional forms used for cathodes. For example, the manganese dioxide can be electrolytic manganese dioxide (EMD) or chemical manganese dioxide (CMD). Distributors of manganese dioxides include Kerr McGee Co. (Trona D), Chem Metals Co., Tosoh, Delta Manganese, Mitsui Chemicals, JMC, and Xiangtan.

Processes for the manufacture of EMD and representative properties thereof are described in “Batteries”, edited by Karl V. Kordesch, Marcel Dekker, Inc., New York, Vol. 1, 1974, pp. 433-488, which is incorporated by reference in its entirety. EMD is the preferred type of manganese dioxide for use in alkaline cells.

The carbon particles may be graphite particles. The graphite can be synthetic graphite including an expanded graphite, non-synthetic graphite, natural graphite, or a blend thereof. Suitable natural graphite particles can be obtained from, for example, Brazilian Nacional de Grafite (Itapecerica, MG Brazil, NdG MP-0702x grade) or Superior Graphite Co. (Chicago, Ill., ABG-grade). Suitable expanded graphite particles can be obtained, for example, from Chuetsu Graphite Works, Ltd. (Chuetsu grades WH-20A and WH-20AF) of Japan or Timcal America (Westlake, Ohio, KS-Grade). The cathode can include, for example, between 2 wt % and 10 wt %, between 3 wt % and 8 wt %, or between 4 wt % and 6 wt % of conductive carbon particles.

Examples of binders include polyethylene, polyacrylic acid, or a fluorocarbon resin, such as PVDF or PTFE. An example of a polyethylene binder is sold under the trade name COATHYLENE HA-1681 (available from Hoechst or DuPont). The cathode can include, for example, between 0.1 wt % and 4 wt %, or between 0.5 wt % and 2 wt % binder.

Examples of other additives are described in, for example, U.S. Pat. Nos. 5,698,315, 5,919,598, and 5,997,775 and U.S. application Ser. No. 10/765,569.

An electrolyte solution can be dispersed through cathode 12, and the weight percentages provided above and below are determined after addition of the electrolyte solution. The electrolyte can be an aqueous solution of alkali hydroxide, such as potassium hydroxide or sodium hydroxide. The electrolyte can contain between 15 wt % and 60 wt %, between 20 wt % and 55 wt %, or between 30 wt % and 50 wt % of alkali hydroxide dissolved in water.

Anodes 14 and 40 can be formed of an anode active material, a gelling agent, and minor amounts of additives, such as gassing inhibitor. In addition, a portion of the electrolyte solution discussed above is dispersed throughout the anode.

Examples of the anode active material include zinc. Any of the standard zinc materials can be used in battery anodes. For example, anodes 14 and 40 can include a zinc slurry that includes zinc metal particles. The zinc particles can be any of the zinc particles conventionally used in slurry anodes. Examples of zinc particles include those described in U.S. Pat. Nos. 6,284,410 and 6,521,378, and U.S. application Ser. No. 09/115,867, each of which is hereby incorporated by reference in its entirety. The anode can include, for example, between 60 wt % and 80 wt %, between 65 wt % and 75 wt %, or between 67 wt % and 71 wt % of anode active materials.

Examples of a gelling agent can include a polyacrylic acid, a grafted starch material, a salt of a polyacrylic acid, a carboxymethylcellulose, a salt of a carboxymethylcellulose (e.g., sodium carboxymethylcellulose) or combinations thereof. Examples of a polyacrylic acid includes CARBOPOL 940 and 934 (available from B.F. Goodrich) and POLYGEL 4P (available from 3V), and an example of a grafted starch material includes WATERLOCK A221 or A220 (available from Grain Processing Corporation, Muscatine, Iowa). An example of a salt of a polyacrylic acid includes ALCOSORB G1 (available from Ciba Specialties). The anode can include, for example, between, between 0.05 wt % and 2 wt %, or between 0.1 wt % and 1 wt % of gelling agent.

A gassing inhibitor can include an inorganic material, such as bismuth, tin, or indium. Alternatively, a gassing inhibitor can include an organic compound, such as a phosphate ester, an ionic surfactant or a nonionic surfactant. Examples of ionic surfactants are disclosed in, for example, U.S. Pat. No. 4,777,100, which is hereby incorporated by reference in its entirety.

Separators 16 and 42 can be a conventional alkaline battery separator. In some embodiments, separators 16 and 42 can be formed of two layers of non-woven, non-membrane material with one layer being disposed along a surface of the other. For example, to minimize the volume of separators 16 and 42 while providing an efficient battery, each layer of non-woven, non-membrane material can have a basic weight of about 54 grams per square meter, a thickness of about 5.4 mils when dry and a thickness of about 10 mils when wet. The layers can be substantially devoid of fillers, such as inorganic particles.

In other embodiments, separators 16 and 42 can include a layer of cellophane combined with a layer of non-woven material. The separator also can include an additional layer of non-woven material. The cellophane layer can be adjacent cathode 12 or 38, or the anode. The non-woven material can contain from 78 wt % to 82 wt % polyvinyl alcohol and from 18 wt % to 22 wt % rayon with a trace amount of a surfactant, such as non-woven material available from PDM under the tradename PA25.

Housings 18 and 44 can be a conventional housing commonly used in primary alkaline batteries, for example, nickel plated cold-rolled steel. The housing can include an inner metal wall and an outer electrically non-conductive material such as a heat shrinkable plastic. Optionally, a layer of conductive material can be disposed between the inner wall and cathode 12 or 38. The layer can be disposed along the inner surface of the inner wall, along the circumference of cathode 12 or 38, or both. The conductive layer can be formed, for example, of a carbonaceous material (e.g., colloidal graphite), such as LB1000 (Timcal), Eccocoat 257 (W.R. Grace & Co.), Electrodag 109 (Acheson Colloids Company), Electrodag EB-009 (Acheson), Electrodag 112 (Acheson) and EB0005 (Acheson). Methods of applying the conductive layer are disclosed in, for example, Canadian Patent No. 1,263,697, which is hereby incorporated by reference in its entirety. Optionally, a corrosion-resistant coating such as gold, titanium nitride or titanium oxynitride can be applied to the inner metal wall of the housing.

Current collectors 20 and 46 can be made from a suitable metal, such as brass. Seals 22 and 48 can be made, for example, of a nylon.

### EXAMPLE

In this illustrative example, a AA battery having sealing 22 as shown in FIG. 1 is discharged and the deformation of the battery housing is measured.

A AA battery is prepared in a conventional way. The AA battery includes a cathode that has about 88.7 wt % of manganese dioxide, about 4.5 wt % of graphite, about 2.5 wt % of potassium hydroxide, and about 4.5 wt % of water, an anode that includes conventional zinc slurry, and a conventional separator. The cathode has a porosity of about 27%. The cathode, anode, and separator are housed in a battery housing that is made of nickel plated steel. The housing includes a wall that includes three layers. The first layer has a thickness of 0.00254 mm, the second layer has a thickness of 0.00254 mm, and the third layer between the first and second layer has a thickness of 0.00432 mm.

The AA battery is then discharged in a repeated cycle, during which it is discharged at 1 Ampere for one hour and let rest for two hours, until the voltage of the battery reaches 0.8 V.

The outer diameter of the AA battery housing is measured before and after the discharge process using ring gages. Before discharge, the outer diameter of the housing is 14.01 mm, and after discharge, the outer diameter of the housing is 14.15 mm. The diameter of the can is distorted by less than 1.0%.

Other embodiments are in the following claims.

What is claimed is:

1. A AA battery comprising:
a housing;
an anode within the housing;
a cylindrical cathode, within the housing and including an interior surface having a surface area of at least 1240 mm² adjacent to the anode; and
a separator between the anode and the cathode.

2. The AA battery of claim 1, wherein the surface area of the interior surface is at least 1250 mm².

3. The AA battery of claim 1, wherein the surface area of the interior surface is at least 1278 mm².

4. The AA battery of claim 1, wherein the surface area of the interior surface is between 1250 mm² and 1320 mm².

5. The AA battery of claim 1, wherein the cathode has a height of at least 44.6 mm.

6. The AA battery of claim 1, wherein the cathode has a height of at least 45.5 mm.

7. The AA battery of claim 1, wherein the cathode has a porosity of at least 26%.

8. The AA battery of claim 1, wherein the anode comprises zinc.

9. The AA battery of claim 1, wherein the cathode comprises electrolytically synthesized manganese oxide.

10. A AAA battery comprising:
a housing;
an anode within the housing;
a cylindrical cathode, within the housing and including an interior surface having a surface area of at least 795 mm² adjacent to the anode; and
a separator between the anode and the cathode.

11. The AAA battery of claim 10, wherein the surface area of the interior surface is at least 800 mm².

12. The AAA battery of claim 10, wherein the surface area of the interior surface is between 800 mm² and 838 mm².

13. The AAA battery of claim 10, wherein the cathode has a height of at least 39.1 mm.

14. The AAA battery of claim 10, wherein the cathode has a height of at least 39.3 mm.

15. The AAA battery of claim 10, wherein the cathode has a porosity of at least 26%.

16. A AA battery comprising:
a housing;
an anode within the housing;
a cathode within the housing, the cathode having a height of at least 44.6 mm; and
a separator between the anode and the cathode.

17. The AA battery of claim 16, wherein the height of the cathode is at least 44.9 mm.

18. The AA battery of claim 16, wherein the height of the cathode is at least 45.5 mm.

19. The AA battery of claim 16, wherein the height of the cathode is at least 45.8 mm.

20. The AA battery of claim 16, wherein the height of the cathode is between 44.6 mm and 46.8 mm.

21. The AA battery of claim 16, wherein the cathode is cylindrical.

22. The AA battery of claim 16, wherein the cathode has a porosity of at least 26%.

23. A AAA battery comprising:
a housing;
an anode within the housing;
a cathode within the housing, the cathode having a height of at least 39.0 mm; and
a separator between the anode and the cathode.

24. The AAA battery of claim 23, wherein the height of the cathode is at least 39.1 mm.

25. The AAA battery of claim 23, wherein the height of the cathode is at least 39.3 mm.

26. The AAA battery of claim 23, wherein the height of the cathode is at least 39.5 mm.

27. The AAA battery of claim 23, wherein the height of the cathode is between 39.1 mm and 40.5 mm.

28. The AAA battery of claim 23, wherein the cathode is cylindrical.

29. The AAA battery of claim 23, wherein the cathode has a porosity of at least 26%.
